(19) United States
(12) Patent Application Publication
(10) Pub. No.: US 2024/0267732 A1
(43) Pub. Date: Aug. 8, 2024

(54) CONTROL PLANE ONLY MOBILE DEVICE NETWORK ACCESS AUTHENTICATION

(71) Applicant: Cox Communications, Inc., Atlanta, GA (US)

(72) Inventor: Tushar SHARMA, Chantilly, VA (US)

(73) Assignee: Cox Communications, Inc., Atlanta, GA (US)

(21) Appl. No.: 18/605,155

(22) Filed: Mar. 14, 2024

Related U.S. Application Data
(63) Continuation-in-part of application No. 18/067,454, filed on Dec. 16, 2022.

(51) Int. Cl. H04W 12/069; H04W 12/0431; H04W 12/72

(52) U.S. Cl. CPC H04W 12/069; H04W 12/0431; H04W 12/72

(57) ABSTRACT

A Mobile Virtual Network Operator (MVNO) network utilizes MNVO-controlled equipment to control generation of public-private key pairs, provisioning of user devices using a public-private key pair, and authenticating user devices requesting access to an MVNO network using the public-private key pair. When the mobile user device requests access to an MVNO network, an MNVO-controlled authentication server requests an encrypted Subscriber Identity Mobile (SIM)-based identity from the user device and uses a key to decrypt the SIM-based identity as part of determining whether to grant MVNO network access to the user device. Encrypted SIM-based identities enable an MVNO to rely on MVNO-controlled equipment when authenticating user devices to access MVNO network without the additional message overhead accumulated when an MNO mobile core is required to determine whether to grant access to user devices.

### CROSS-REFERENCE TO RELATED APPLICATIONS

This application is a continuation-in-part of U.S. patent application Ser. No. 18/067,454, filed Dec. 16, 2022, the disclosure of which in incorporated herein by reference, in its entirety.

### BACKGROUND

Today's modern communication infrastructure enables users the flexibility of being mobile while using end-user devices to transact personal and business tasks. Handheld mobile end-user devices, such as smartphones and tablets for example, can be equipped with multiple wireless interface types, such as cellular network interfaces (4G, 5G, etc.) and wireless networking interfaces developed according to the Institute of Electrical and Electronics Engineers (IEEE) standards, such as IEEE 802.11 type (e.g., WiFi), IEEE 802.15 type (e.g., BLUETOOTH), etc. Multiple radios can be included in these mobile devices, each radio communicating with these various network interfaces. Different types of networking equipment are readily available from multiple vendors to set up home and business networks for use with handheld end-user devices. Some of the end-user devices can be configured through device settings to select a primary network preference (e.g., WiFi) and a backup network preference (e.g., cellular radio).

The conveniences attributed to the modern communication infrastructure and various communication protocols are not without limitations. For instance, live calls and remote videoconferencing require strict handoff tolerances so that packets are not dropped or corrupted when moving between different locations and/or types of networks. As an example, when transitioning from a first network type (e.g., IEEE 802.11 network) to a second network type (e.g., cellular network), the amount of time that it takes for a user device to access and connect to the second network is critical to handing over the communication session. If it takes too long to access and connect to the second network, the handover suffers and packets can be lost or corrupted which adversely impacts the communication session. In extreme delays, the call can be dropped.

Access to cellular networks are typically provided to subscribers of Service Providers (SP) by a Mobile Network Operator network (MNO) or a Mobile Virtual Network Operator (MVNO) network. One technical problem facing an MVNO is not having control over authentication mechanisms required by an MNO since the equipment and/or infrastructure is controlled by the MNO. For example, in order to authenticate that a user is authorized to access an MVNO network, the MVNO may be required to send authentication request messages to an MNO mobile core, which has an authentication server and associated Home Subscriber Server (HSS) or Unified Data Manager (UDM)/Unified Data Repository (UDR). These additional messages sent to the MNO, including the amount of time required to send and receive authentication request/response data, adds additional overhead to the authentication process and contributes to an amount of latency associated with a communication session. Moreover, sensitive information may be compromised since the MVNO has little control over what an MNO does with the authentication data. Additionally, the authentication algorithms/protocols utilized, and therefore required by, the MNO may be out of date, contrary to the standards required within the MVNO network, and may subject the data flow within the MVNO to be compromised. A technical solution is needed to reduce the amount of time required to access and connect to a preferred wireless communication network. A technical solution is also needed to reduce the amount of time required to transition from one network type to a different network type which may result in improved handover with fewer dropped or corrupt packets during a communication session. A technical solution is further needed so the MVNO is not limited nor compromised by the authentication protocols utilized by the MNO.

Modern mobile devices can be supported by more than one Service Provider (such as an MNO). The SP can be a Public Cellular, Private Cellular, Public WiFi network, Private WiFi network, or any combination thereof. Authentication of the subscriber (user of a mobile device) depends on credentials provided by the mobile device on behalf of the subscriber. Credentials can be stored on the mobile device using a physical Subscriber Identity Mobile (SIM) card or an embedded SIM (eSIM). The SIM/eSIM contains an International Mobile Subscriber Identifier (IMSI) identifying the mobile device to any network that is capable of providing access. Current mobile OS implementations allow MVNO-specific attributes to be stored on a SIM/eSIM, which are made available to the mobile device, which in turn aid in subscriber authentication based on proper network identification prior to permitting network access by the mobile device.

The subscriber IMSI is encrypted using a Public/Private key pair, as defined in WBA IMSI Privacy Protection for WiFi. However, the handshaking technology associated with the discovery and authentication of a subscriber IMSI is currently limited to a request from an Extensible Access Point (EAP) server to an EAP supplicant using an ASKA-Identity (AT_ANY_ID_REQ) Challenge. The limitation of this technology can be improved by using TLS-based protocols to request the encrypted IMSI using TLS extensions supported in an EAP-TLS client hello message. A technical solution is needed to reduce the amount of time required to securely access and connect to a preferred wireless communication network. A technical solution is also needed to reduce the amount of time required to transition from one network type to a different network type, thereby resulting in improved handover with fewer dropped or corrupt packets during a communication session. Further, a technical solution is needed to secure the information of an MVNO network from uncontrolled access to the information within an MNO network. Each of these problems can be solved by the novel and unconventional techniques and device handshaking disclosed herein.

### SUMMARY

According to aspects disclosed herein, an MVNO utilizes MVNO-controlled equipment to authenticate user devices requesting access to the MVNO network, but are not limited to whatever authentication and hand-shaking protocols being used by the MNO, control over which the MVNO network rarely has. According to an aspect, an MVNO utilizes MVNO-controlled equipment to control generation of public-private key pairs, provisioning of user devices using a public-private key pair, and authenticating user devices requesting access to the MVNO network using the public-private key pair. According to an aspect, an MVNO-controlled provisioning server can be configured to use a key of a public-private key pair to encrypt a Subscriber Identity Module (SIM)-based Mobile Subscriber Identifier (IMSI) that is associated with a user mobile device. When the user device requests access to the MVNO network, the MVNO-controlled authentication server can be configured to request an encrypted IMSI from the user device and use a key of the public-private key pair to decrypt the encrypted IMSI identity as part of determining whether to grant MVNO network access to the user device. Encrypted IMSI's enable an MVNO to rely on MVNO-controlled equipment when authenticating user devices to access the MVNO network without the additional message overhead accumulated when an MNO mobile core is required to determine whether to grant access to user devices.

There is also disclosed a method and system for securely connecting to a wireless network with control plane only authentication, including initiating, from a wireless radio on a mobile device, a connection for transmitting and receiving data; establishing a service provider authentication between the mobile device and an authentication server through a wireless local area network controller (WLC); and establishing extensible authentication protocol transport layer security (EAP-TLS) as an authentication protocol for authenticating the mobile device to the authentication server. The process further includes transmitting an encrypted unique identifier for the mobile device from the mobile device to the authentication server, the transmission including a serial number for a certificate for a public key for the encrypted unique identifier; decrypting at the authentication server the encrypted unique identifier. If authentication of the mobile device at the authentication server, based on the decrypted unique identifier, is successful, transmitting from the authentication server to the mobile device a certificate for the authentication server. If authentication of the transmitted server certificate at the mobile device is successful, a certificate for the mobile device is transmitted from the mobile device to the authentication server. Further, an encryption algorithm for encrypting information to be transmitted and received by the mobile device is received by the mobile device from the authentication server; and data plane transmission by the mobile device to the WLC is commenced.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which embodiments disclosed herein are based.

### BRIEF DESCRIPTION OF THE DRAWINGS

The present invention has other features and advantages which will be apparent from or are set forth in more detail in the accompanying drawings, which are incorporated herein, and the following Detailed Description, which together serve to explain certain principles of the present invention and to enable a person of ordinary skill in the art to make and use the embodiments disclosed herein. In the drawings, like reference numbers indicate identical or functionally similar elements. A brief description of the drawings is as follows:

FIG. 1 is a block diagram of an exemplary communication environment for authenticating user devices, according to an aspect.

FIG. 2 is a flow diagram of an exemplary method of using an authentication server to control access to an MVNO network, according to an aspect.

FIG. 3 is a flow diagram of an exemplary method of generating a public-private key pair, according to an aspect.

FIG. 4 is a flow diagram of an exemplary method of provisioning service to a user device in order to access an MVNO network, according to an aspect.

FIG. 5 is a high-level communication diagram of generating a public-private key pair, according to an aspect.

FIG. 6 is a high-level communication diagram of provisioning a new user device including public key encryption of IMSI data to control access and use of an MVNO network, according to an aspect.

FIG. 7 is a high-level communication diagram of an authentication server performing authentication operations with a user device before allowing access to an MVNO network, according to an aspect.

FIG. 8 is a block diagram illustrating example physical components of a computing device with which aspects may be practiced.

FIGS. 9A-9B illustrate a suitable mobile computing device with which aspects can be practiced.

FIG. 10 is a block diagram of an exemplary communication environment for performing control plane only mobile device network access authentication, according to an aspect.

FIGS. 11A-11B are flow diagrams of an exemplary method for securely connecting a mobile device to a wireless network with control plane only authentication.

FIG. 12 is a flow diagram of an exemplary method for securely connecting a mobile device to a wireless network with control plane only authentication.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes can be determined in part by persons of ordinary skill in the art for the particular intended application and use environments.

### DETAILED DESCRIPTION

The novel features, including methods and systems, disclosed herein are directed to the technology of mobile communication. While mobile communication has been implemented for many years, improvements to the mobile communication technology continues to advance, some of those advancements and improvements being disclosed herein. The particular technological improvements disclosed above and below address and solve the technological problems discussed above and provide improvements in the technology of mobile communication and, by solving those problems, thereby provide a practical application for facilitating secure authentication of a mobile device before permitting data access to a network. In particular, embodiments disclosed herein transform the technology of providing authorized access between a mobile device and a mobile network into a novel, non-conventional of network access authorization system and method that saves time, reduces latency and dropped calls, and improves security of data within the network.

The technical solutions disclosed herein enhance known authentication protocols and thereby provide a practical solution to the above problems and the problems associated with being required to utilize whatever protocols the MNO network utilizes. These solutions can be provided by embodiments disclosed in this specification wherein network authentication is provided through the MVNO without exposing sensitive information to non-MVNO network components and users.

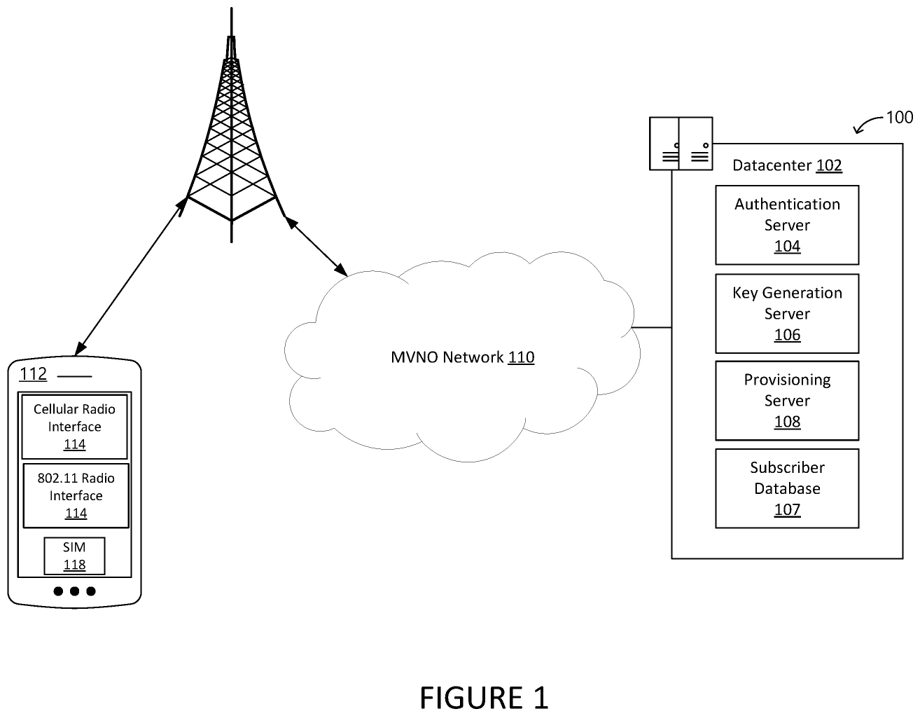

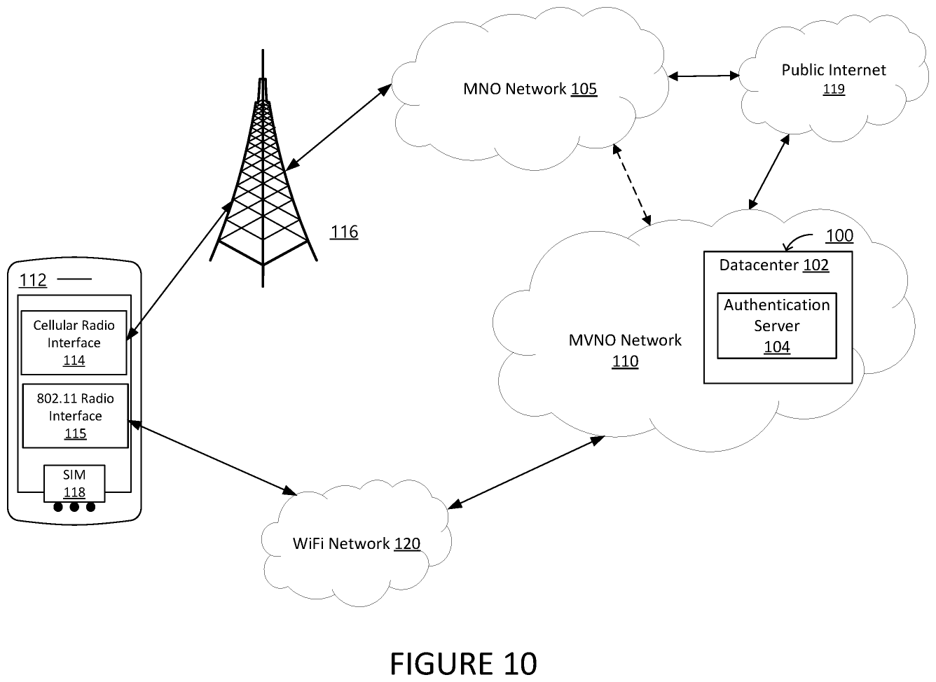

Reference will now be made in detail to exemplary aspects of the present disclosure that are illustrated in the accompanying drawings. Although the described embodiments can be implemented in any appropriate type of network system supporting any suitable communication standards and using any suitable components, particular embodiments can be implemented in an exemplary network such as shown in FIG. 1 and FIG. 10.

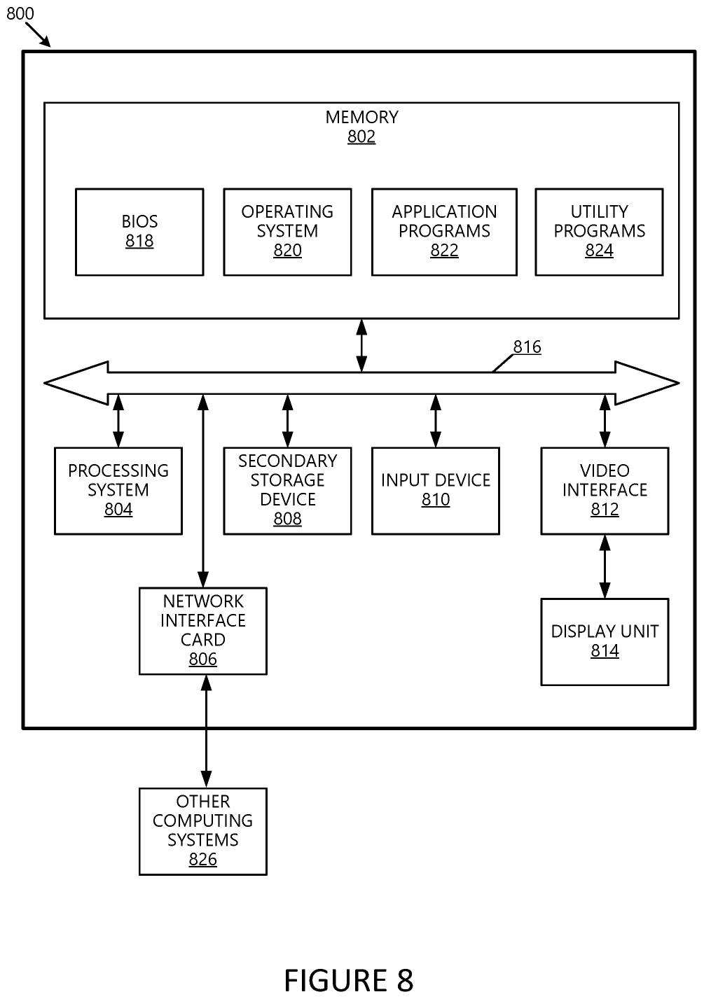

FIG. 1 is a block diagram of an exemplary communication environment 100 for authenticating user devices when attempting to access mobile virtual network operator (MVNO) network 110, but is not so limited. According to an aspect, datacenter 102 of MVNO includes an authentication server 104, a key generation server 106, a provisioning server 108, and a subscriber database 107. While a single datacenter 102 is depicted, MVNO can include multiple datacenters at different physical locations. Each of the authentication server 104, key generation server 106, provisioning server 108, and/or subscriber database 107 can be implemented using a corresponding physical server machine. According to one aspect, a first physical server machine includes authentication server 104 and subscriber database 107, a second physical server machine includes key generation server 106, and a third physical server machine includes provisioning server 108. Each server machine includes at least one processor and memory (see example of FIG. 8), wherein the memory stores instructions which, when executed by at least one processor, provide functions of each of the authentication server 104, key generation server 106, and provisioning server 108. Additionally, each server machine can be configured with additional functionality or components and the various aspects described herein are not intended to be limited by this description.

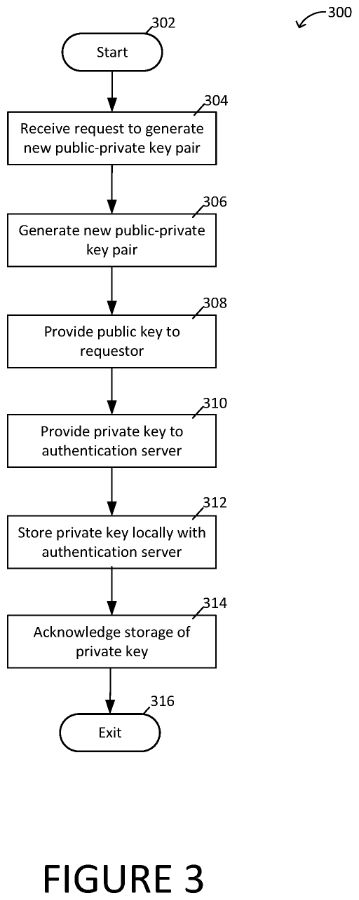

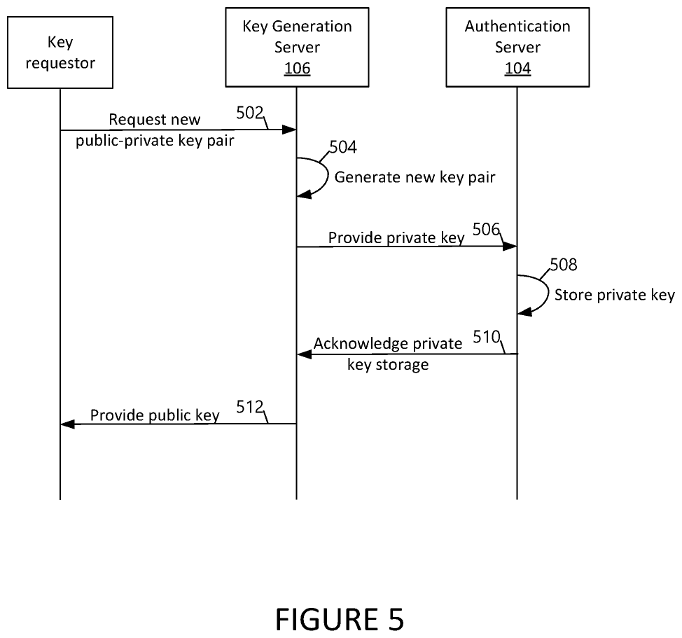

As described below in conjunction with FIGS. 3 and 5, key generation server 106 can be configured to generate a public-private key pair for use in provisioning devices for MVNO network 110 and/or for authenticating devices wishing to access MVNO network 110. For example, provisioning server 108 can use the public key of a public-private key pair to encrypt subscriber identity module (SIM)-based identities that are associated with user devices 112 as part of onboarding new subscribers. The user device 112 is described herein variously as a user device, a mobile device, and a mobile computer device, each such identifier representing the same mobile device capable of communications and network access. After receiving a request to access MVNO network 110 from a user device 112, authentication server 104 can use the private key of the public-private key pair to decrypt a SIM-based identity as part of determining whether to allow access to MVNO network 110. As described further below, authentication server 104 can refer to subscriber database 107 as part of determining whether to allow user device 112 to access MVNO network 110.

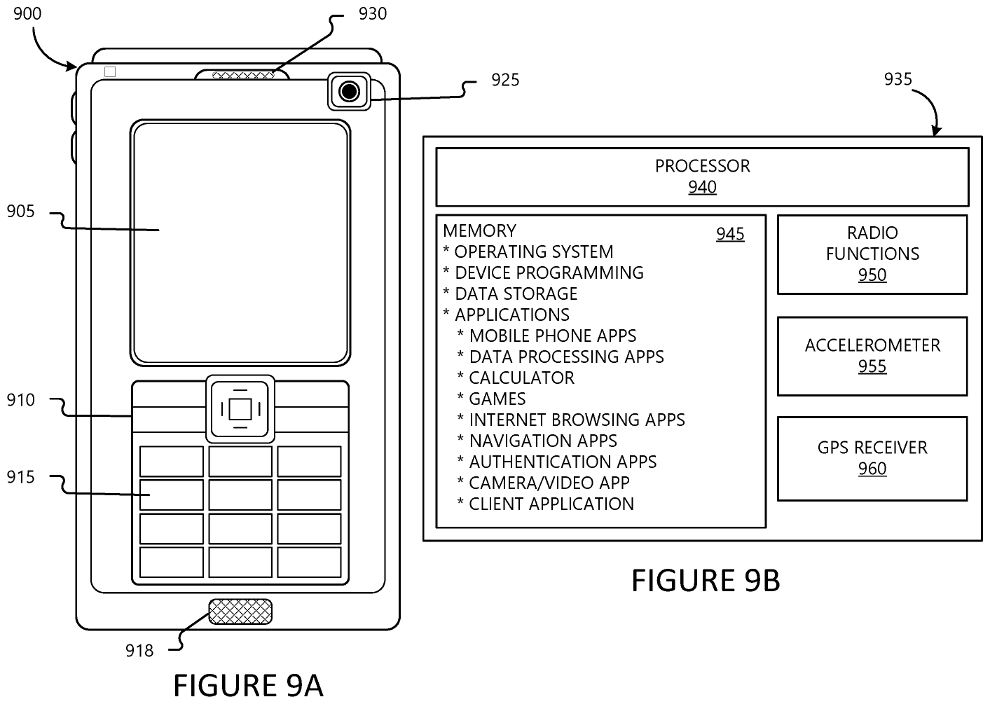

As shown in the example of FIG. 1, user device 112 (see for example FIGS. 9A and 9B) can include at least two wireless interfaces, a cellular radio interface 114 (e.g., LTE, 4G, 5G, etc.) and an Institute of Electrical and Electronics Engineers (IEEE) 802.11 radio interface 115 (e.g., WiFi). In some embodiments, the user device 112 can include only one wireless interface (that of the 802.11 radio interface) or more than two radio interfaces. As described below, depending on signal quality performance, and/or other communication issues, user device 112 can be configured to switch from one wireless interface to another. For example, if user device 112 is currently operating as a WiFi-client and the WiFi signal becomes unusable, user device 112 can be configured to automatically switch over to cellular radio interface 114 to access MVNO network 110. User device 112 includes at least one SIM 118 such as a removable SIM card and/or an embedded SIM (eSIM).

As described below, an MVNO is able to use authentication server 104 to control access to MVNO network 110 without using Mobile Device Management (MDM) or having to contact a Home Subscriber Server (HSS) or Unified Data Manager (UDM)/Unified Data Repository (UDR) of a mobile network operator (MNO) (i.e., the MNO mobile core). As a technical result, an MVNO is able to reduce communication latency within communication environment 100 as well as reducing the amount of time it takes to access MVNO network 110 resulting in improved handovers. An MVNO is also able to securely control access to MVNO network 110 by bypassing an HSS or UDM/UDR of an MNO. Correspondingly, an MVNO is able to control which user devices 112 access MVNO network 110 as well as protecting sensitive data by preventing unauthorized access to user data by MNO authentication equipment. Moreover, the number of communication hops is reduced by bypassing MNO authentication equipment which may result in reduced latency and improved communication sessions.

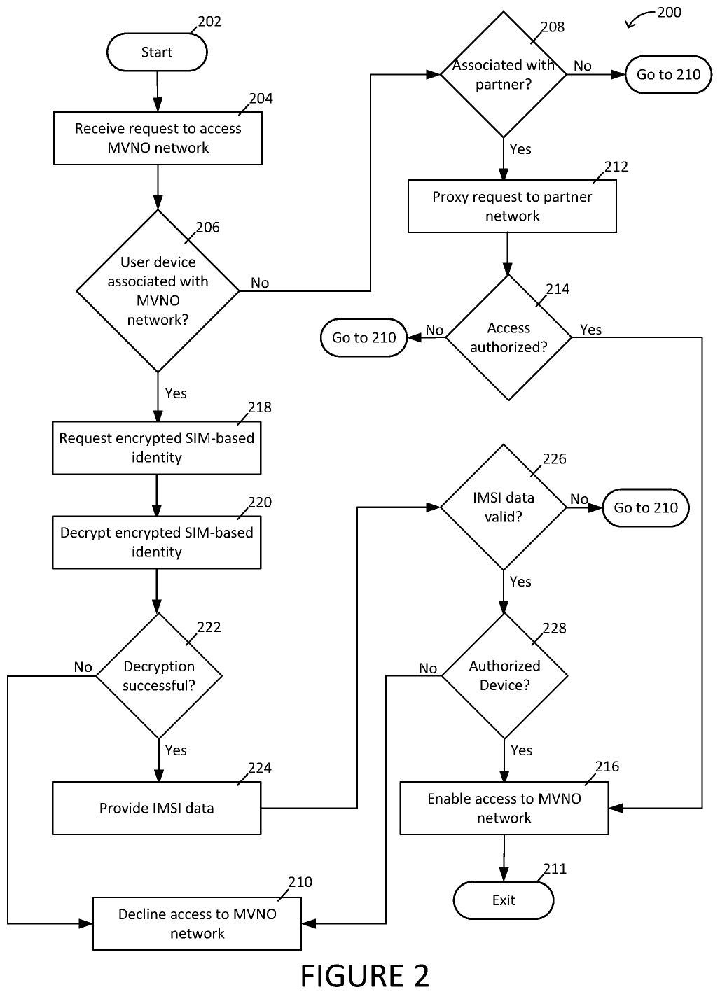

FIG. 2 is a flow diagram of an exemplary method 200 of using authentication server 104 to control access to MVNO network 110, according to an aspect. Method 200 is configured to enable access to MVNO network 110 without using MDM or having to contact an HSS or UDM/UDR of an MNO. Accordingly, method 200 is able to reduce communication latency as well as reducing the amount of time to enable access to MVNO network 110 which may result in fewer dropped or corrupted packets. Method 200 begins at 202 and proceeds to 204 where authentication server 104 receives, from a user device 112, a network access request to access the MVNO network 110. According to an aspect, authentication server 104 can be configured as a standalone server machine located in datacenter 102, wherein the standalone server machine includes at least one processor and memory where method 200 comprises a set of executable instructions stored in memory.

If user device 112 is not associated with MVNO network 110 at 206, method 200 proceeds to 208 and determines if user device 112 is associated with a partner network. According to one aspect, method 200 uses authentication server 104 to extract an outer identity, such as a Mobile Country Code (MCC) and a Mobile Network Code (MNC) for example, from the user request as part of determining whether user device 112 is associated with MVNO network 110 or a partner network. For example, a determination can be made by authentication server 104 if the MCC has a particular value and MNC has a particular value (e.g., MCC=310 and MNC=480) when determining whether user device 112 is associated with MVNO network 110 or a partner network. As an example, an outer identity typically does not provide any device-specific information. For example, if IMSI privacy protection is enabled, a device will initially respond with anonymous@ <NAI Realm>. The NAI realm format for an outer identity is wlan.mncXXX.mccYYY, where XXX is replaced with the SIM mobile network code (MNC) and YYY is replaced with the mobile country code (MCC). An inner identity provides device identification information and is typically encrypted to avoid privacy issues and trackability.

If user device 112 is not associated with a partner network at 208, method 200 proceeds to 210 and declines access to MVNO network 110 before exiting at 211. If user device 112 is associated with a partner network at 208, at 212 method 200 proxies the access request to the partner network. If the partner network authenticates user device 112 at 214, method 200 enables access to MVNO network 110 at 216. If the partner network does not authenticate user device 112 at 214, method 200 declines access to MVNO network 110 at 210 before exiting at 211.

If user device 112 is associated with MVNO network 110 at 206, method 200 proceeds to 218 and requests an encrypted SIM-based identity from user device 112. According to one aspect, the SIM-based identity is associated with at least one SIM of the user device, such as one or more removable SIM cards and/or eSIMs. As described further below, a provisioning service of provisioning sever 108 can be configured to use a public-private key pair (e.g., a public key) to generate an encrypted SIM-based identity that includes an encrypted concatenation of the MCC, MNC, and a mobile telephone number or other identifier of user device 112. The encrypted SIM-based identity can be provided to user device 112 as part of a subscription onboarding process and stored in secure storage of user device 112, such as an impenetrable or tamper-proof hardware storage (e.g., secure enclave).

After receiving the encrypted SIM-based identity, at 220, method 200 uses authentication server 104 to decrypt the encrypted SIM-based identity using the public-private key pair (e.g., a private key). If the decryption operation is unsuccessful at 222, method 200 declines access to MVNO network 110 at 210 before exiting at 211. If the decryption operation is successful at 222, method 200 proceeds to 224 and provides International Mobile Subscriber Identity (IMSI) data that is associated with the SIM-based identity. For example, at 224 method 200 provides an MCC, an MNC, and a 0-9 digit number resulting from the decryption operation.

If the IMSI data is invalid at 226, method 200 declines access to MVNO network 110 at 210 before exiting at 211. For example, method 200 can use authentication server 104 to lookup valid numbers and formats for the MCC, MNC and mobile telephone number as part of the validation operation. If the IMSI data is valid at 226, method 200 proceeds to 228 to determine whether user device 112 is authorized to access MVNO network 110. According to an aspect, at 228, method 200 uses subscriber database 107 to determine whether user device 112 is authorized to access MVNO network 110.

For example, authentication server 104 can perform a lookup operation in subscriber database 107 to determine whether the decrypted IMSI data matches IMSI data and mobile device protocols that were provided at the time of provisioning services for the subscriber. If method 200 determines from the subscriber database that user device 112 is unauthorized to access MVNO network 110 at 228, method 200 declines access to MVNO network 110 at 210 before exiting at 211. If method 200 determines that user device 112 is authorized to access MVNO network 110 at 228, method 200 grants access to MVNO network at 216 before exiting at 211.

FIG. 3 is a flow diagram of an exemplary method 300 of generating a public-private key pair, according to an aspect. The generated public-private key pair can be used as part of provisioning user devices as part of onboarding new subscribers to MVNO network 110 as well as authenticating user devices that request access to MVNO network 110. Method 300 can be configured to generate a public-private key pair automatically or on-demand. For example, an automated process can be used to automatically generate a new public-private key pair upon detection that a currently implemented private key of a public-private key pair has been compromised or is otherwise required to be renewed (e.g., a time to expire or time to live has passed). As another example, an authorized user can send a request from a user device or workstation to key generation server 106 requesting that a public-private key pair be generated.

With continuing reference to FIG. 3, method 300 begins at 302 and proceeds to 304 receiving a request to generate a public-private key pair. As described above, the request may be automated or submitted by an authorized user. At 306, method 300 uses key generation server 106 to generate a new public-private key pair. For example, key generation server 106 can be configured to generate a 2048-bit private-public key pair which can be stored on key generation server 106. A time to live value can be associated with the public-private key pair so that new public-private key pairs are generated according to a temporal preference.

At 308 method 300 uses key generation server 106 to provide the public key of the new public-private key pair to the key generation requestor. For example, key generation server 106 can provide a public key of the new public-private key pair to provisioning server 108 to use for encrypting SIM-based identities for user devices of subscribing users and/or store the public key locally with key generation server 106. In some cases, method 300 also stores the public key locally in computer storage associated with the key generation requestor as well as acknowledging local storage operations.

At 310, method 300 provides the private key of the new public-private key pair to authentication server 104 for use when authenticating user devices requesting access to MVNO network 110. For example, key generation server 106 can provide a private key of the new public-private key pair to authentication server 104 to decrypt SIM-based identities of user devices requesting access to MVNO network 110. At 312, method 300 stores the private key locally with authentication server 104. For example, method 300 can be configured to encrypt and store the private key in an escrow store, such as a secure hardware storage location of authentication server 104. At 314, method 300 uses authentication server 104 to send a message to key generation server 106 acknowledging that the private key has been stored before exiting at 316.

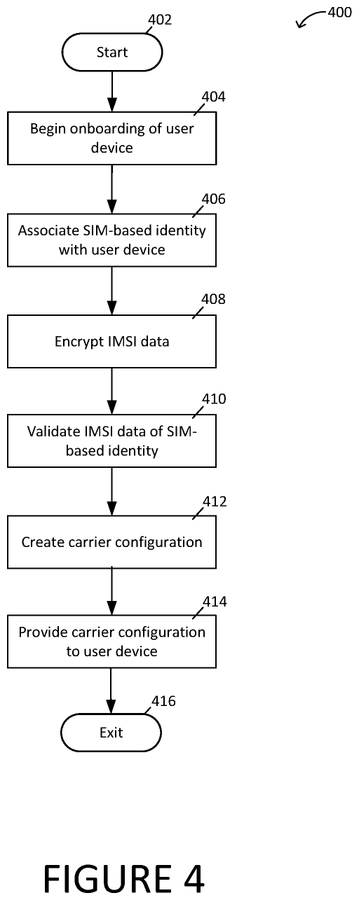

FIG. 4 is a flow diagram of an exemplary method 400 of provisioning service to a user device 112 in order to access MVNO network 110, according to an aspect. For example, method 400 can be used when a user would like to utilize user device 112 with MVNO network 110. As described below, method 400 associates a SIM-based identity with each user device as part of subscribing to access MVNO network 110. Method 400 can be configured to provision services so that different types of user devices are able to access MVNO network 110 based in part on encrypted SIM-based identities which are carried by subscribing devices. The encrypted SIM-based identities enable an MVNO to rely on MVNO-controlled authentication equipment when authenticating user devices in order to access MVNO network 110 without requiring authentication by an MNO mobile core.

Method 400 starts at 402 and proceeds to 404 to begin onboarding user device 112 as part of allowing user device 112 to access MVNO network 110. For example, users can purchase new devices or onboard previously purchased devices that are equipped to operate with the specifications of MVNO network 110 (e.g., 4G, 5G, etc.). There are a variety of ways to kickoff onboarding of user devices that will be allowed to access MVNO network 110. For example, users can go to a retail store offering MVNO network service or sign-up over the Internet or other network from a home or business location.

At 406, method 400 uses provisioning server 108 to associate a SIM-based identity with user device 112. For example, a QR-code can be scanned to contact provisioning server 108 to provision services for user device 112 according to a SIM-based identity, such as an IMSI for example. The user device 112 or some other device can be used to scan the QR code to launch the onboarding process and/or associate a unique IMSI (e.g., a number of digits that includes an MCC, an MNC, and a Mobile Subscriber Identification Number (MSIN)) with MVNO network 110. The IMSI is included with a removable SIM card or an eSIM of user device 112.

At 408, method 400 uses provisioning server 108 to encrypt the SIM-based identity using a public-private key pair (e.g., encrypt with the public key) generated by key generation server 106. At 410, method 400 uses provisioning server 108 to validate the IMSI. According to an aspect, validation operations include verifying that an IMSI length is 15/16 digits, verifying that MCC/MNC values are valid for MVNO or Partner MNO/MVNO networks, and/or verifying that the encryption did not fail or handle any other process errors. For example, provisioning server 108 can be configured with a validation mask to validate that the MCC, MNC, and MSIN are valid and do not include errors (e.g., letters). Once the IMSI is validated, method 400 at 412 uses provisioning server 108 to create a carrier configuration that includes the encrypted IMSI for user device 112. The validated IMSI and/or encrypted IMSI can be stored in subscriber database 107. In certain implementations, it may be preferable to perform validation operations before encryption operations. At 414, method 400 uses provisioning server 108 to provide the carrier configuration and encrypted IMSI to user device 112 for storing in secure storage (e.g., secure enclave, etc.).

FIG. 5 is a high-level communication diagram of generating a public-private key pair according to an aspect. At 502, a request is sent to key generation server 106 from a key requestor requesting generation of a new public-private key pair. For example, an MVNO can utilize an automated key renewal process to generate a new public-private key pair or an MVNO administrator (e.g., upon theft of a currently implemented key) can request generation of a new public-private key pair. As described herein, the new public-private key pair can be used for provisioning new devices and authenticating devices requesting access to MVNO network 110. According to one aspect, the new public-private key pair can be used to encrypt and decrypt SIM-based identities of user devices when onboarding new subscribers and/or controlling access to MVNO network 110.

At 504, key generation server 106 generates a new public-private key pair. At 506, key generation server 106 provides the private key of the new public-private key pair to authentication server 104. At 508, authentication server 104 encrypts and stores the private key in escrow storage. At 510, authentication server 104 sends a message to key generation server 106 acknowledging that the private key has been stored. At 512, key generation server 106 provides the public key of the new public-private key pair to the key requestor with a message to publish the public key and replace any previous public key.

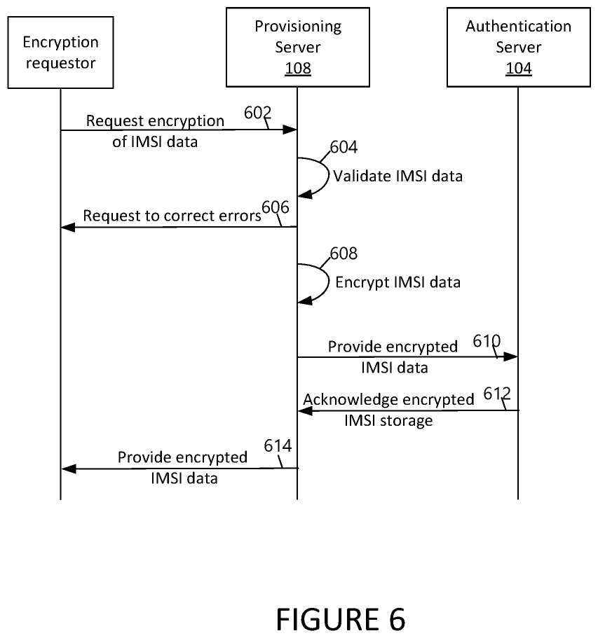

FIG. 6 is a high-level communication diagram of provisioning a new user device including public key encryption of IMSI data to control access and use of MVNO network 110, according to an aspect. At 602, an encryption requestor sends IMSI data with a message to provisioning server 108 to encrypt the IMSI data. For example, an automated process can be used to generate an encryption requestor request when a user first subscribes to MVNO network 110 (e.g., by scanning a QR code) intending to use user device 112. At 604, provisioning server 108 validates IMSI data from a SIM card or an eSIM by checking whether the IMSI data has errors or other issues. If the IMSI data contains one or more errors, at 606, provisioning server 108 sends a message to the encryption requestor with any identified errors for correcting.

The encryption requestor can submit a new request once any errors are corrected. If the IMSI data does not contain any errors, at 608, provisioning server 108 uses the public key of the public-private key pair to encrypt the validated IMSI data. At 610, provisioning server 108 provides the encrypted IMSI data to authentication server 104 for storing for future authentication operations. At 612, authentication server 104 sends a message to provisioning server 108 that acknowledges storage of the encrypted IMSI data. At 614, provisioning server 108 provides the encrypted IMSI to the encryption requestor with a message to publish the encrypted IMSI data and invalidate any previously published encrypted IMSI data.

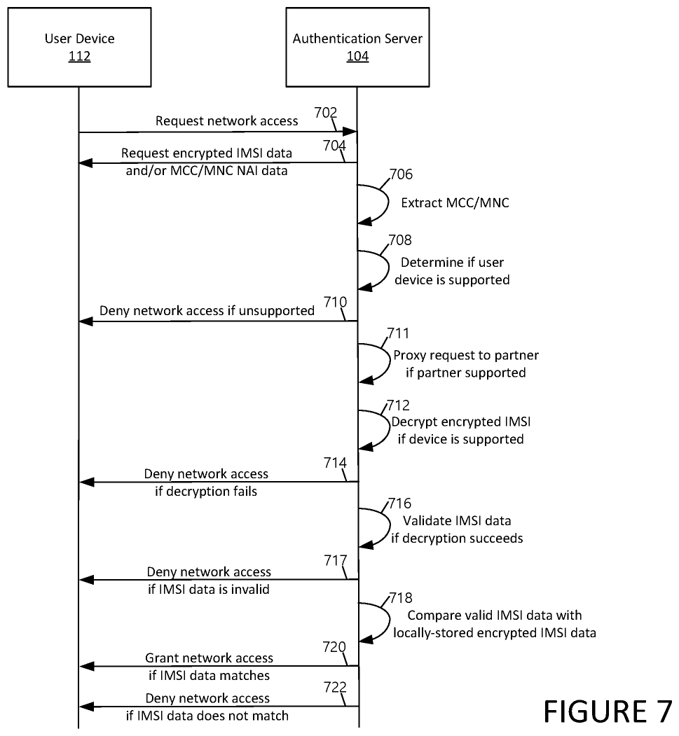

FIG. 7 is a high-level communication diagram of authentication server 104 performing authentication operations with user device 112 to control access to MVNO network 110, according to an aspect. At 702, authentication server 104 receives a request from user device 112 for access to MVNO network 110. For example, a user may be using user device 112 as a WiFi client and the WiFi signal is fading as the user moves away from a WiFi gateway such that user device 112 automatically sends a request to access MVNO network 110 using an integrated cellular radio interface. At 704, authentication server 104 sends a message to user device 112 requesting that user device 112 send encrypted IMSI data and/or unencrypted MCC/MNC network access identifier (NAI) data. Alternatively, user device 112 can be configured to provide the unencrypted MCC/MNC NAI data with the access request at 702.

At 706, authentication server 104 extracts the MCC/MNC values from the unencrypted MCC/MNC NAI data. At 708, authentication server 104 determines whether user device 112 is supported on MVNO network 110 based on the MCC/MNC values. If the user device 112 is not supported on MVNO network 110, authentication server 104 sends a message to user device 112 denying access to MVNO network 110 at 710. If the user device 112 is supported by a partner of MVNO network 110, authentication server 104 sends a proxy message to the partner network at 711. If the user device 112 is supported on MVNO network 110 based on the MCC/MNC values, authentication server 104 decrypts the encrypted IMSI data at 712 with a private key. If the decryption fails for any reason, authentication server 104 sends a message to user device 112 denying access to MVNO network 110 at 714.

If the decryption of the encrypted IMSI data is successful, authentication server 104 validates the IMSI data at 716 by checking whether the IMSI data is free of errors. If the IMSI data has errors, at 717, authentication server 104 sends a message to user device 112 denying access to MVNO network 110. If the IMSI data is free of errors, at 718, authentication server 104 compares the error-free IMSI data with encrypted IMSI data that was stored in local storage (e.g., subscriber database 107) as a result of the provisioning process. According to an aspect, the comparison can be done by either matching the encrypted IMSI to a previously-stored encrypted IMSI or matching the unencrypted IMSI to a previously-stored unencrypted IMSI. The subscriber database 107 can be configured to store both encrypted and unencrypted versions. Security requirements drive whether one or both are stored in persistent storage or not. To avoid issues when ransomware attacks happen, the encrypted version is only stored and decrypted on-the-fly as needed. Some ransomware attacks are configured to scavenge memory buffers of computers for such data which may limit storing decrypted IMSIs on authentication server 104. If the previously-stored IMSI data matches the error-free IMSI data, at 720, authentication server 104 sends a message to user device 112 granting access to MVNO network 110. If the previously stored IMSI data does not match the error-free IMSI data, at 722, authentication server 104 sends a message to user device 112 denying access to MVNO network 110.

Referring now to FIG. 10, there is shown a block diagram of an exemplary communication environment for performing control plane only mobile device network access authentication, according to an aspect. The cellular radio interface 114 of the user device 112 communicates with an MNO network 105, alternatively via one or more towers 116. In contrast, communications to and from the 802.11 radio interface 115 communicates with a WiFi network 120. Through the WiFi network 120, the radio interface 115 communicates with the MVNO network 110. This embodiment does not disclose communication between the MVNO network 110 and the MNO network 105, other than the dotted line representing back office sharing, such as user device identification, account information, user device activation information, and subscription information. From the MNVO network 110, the radio interface 115 has access to other networks, the public internet 119 being shown as representative. The exemplary communication environment 100 and its components are shown as being part of the MNVO network 110, but this environment 100 is not so limited in that it can be part of a partner network, with connections to the MNVO network 110. Further, the components of the exemplary communication environment 100 have been simplified from FIG. 1, the additional components described in conjunction with the exemplary computer environment of FIG. 1 can be included in the exemplary communication environment 100 of FIG. 10 as needed.

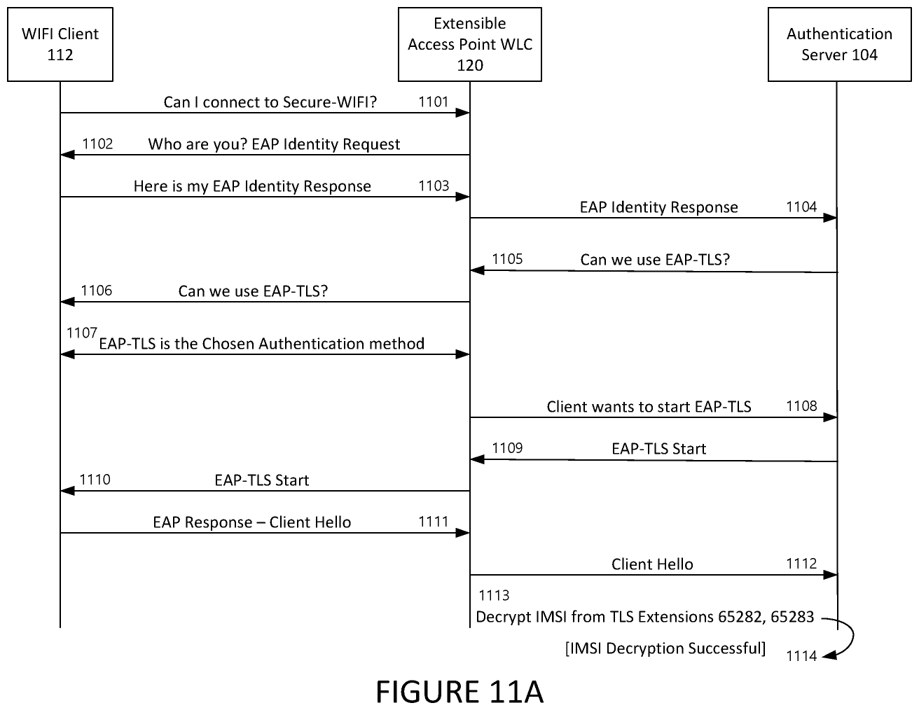

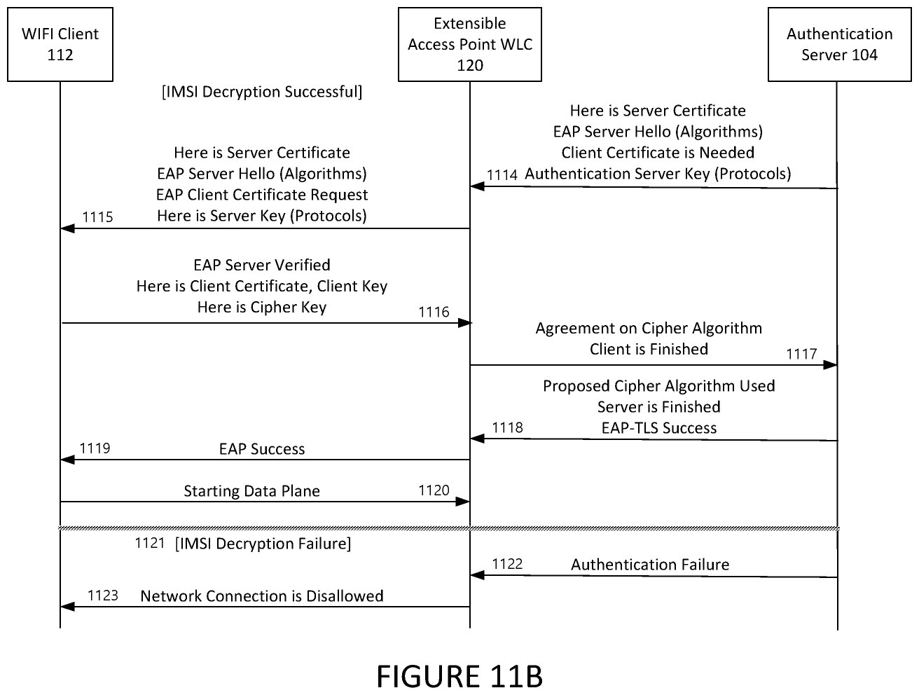

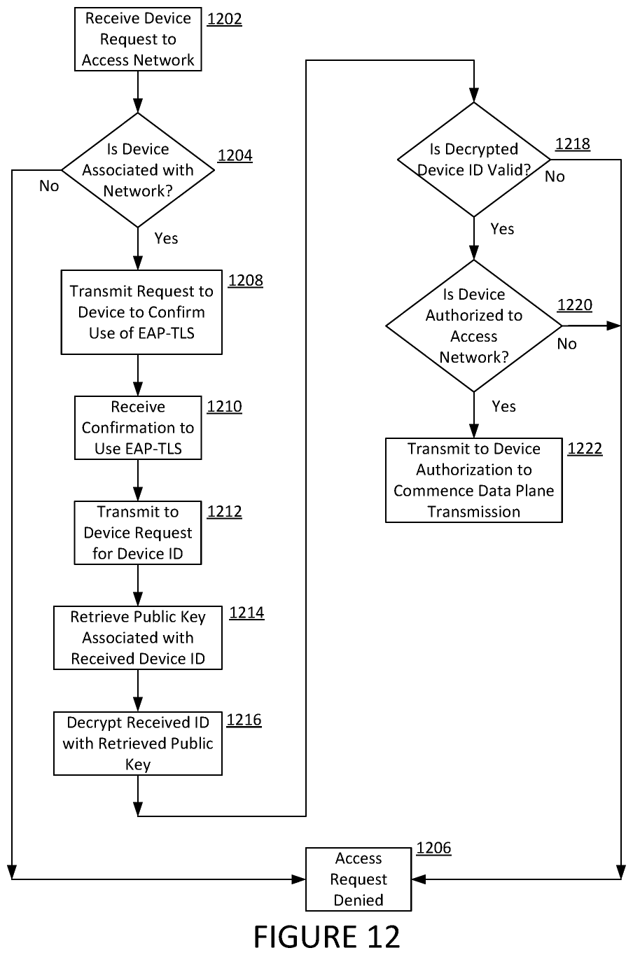

Referring now to FIG. 11A, there is shown a flow diagram of an exemplary method for securely connecting a mobile device to a wireless network with control plane only authentication, according to an aspect. Authentication of a user to access a wireless network is accomplished within an embodiment disclosed herein by verifying that an encrypted IMSI within the user device is valid. Currently, a specific protocol known as an Authentication Key Agreement (AKA) is used in the wireless communication industry for performing authentication of a mobile device. Additionally, Transport Layer Security (TLS) is a cryptographic protocol designed to allow for private and secure communication over a computer network. Instead of utilizing components and protocols of an MNO network/server, authorization embodiments herein utilize TLS protocol extensions for SIM-based authentication to support features provided in the AKA, thereby permitting user device authentication through MVNO resources. In particular, TLS public key extensions of an encrypted IMSI (65282) and an encrypted IMSI certificate number (65283) contained within the user device are utilized to determine whether the user (via the user device) is authorized to access the MVNO network 110 (and subsequent networks 119). These extensions allow recognition of the mobile device as an individual, authorized subscriber. Since the encrypted IMSI and IMSI certificate number are already located on the user device 112 and the authentication server 104, no modifications to the information on the devices shown in FIG. 10 are needed to authenticate the user device. The extended TLS protocols can be called ETLS protocols, and this new authentication process can be termed ETLS/TLS authentication. The steps how this process is accomplished are disclosed in the steps discussed below in accordance with FIG. 11A, FIG. 11B, and FIG. 12.

FIG. 11A shows a WiFi client 112, corresponding to the user device 112 shown in FIG. 1 and FIG. 10, the WiFi client including 802.11 radio interface 115. Also shown is an Extensible Access Point (EAP) Wireless Local Area WiFi Network Controller (WLC), corresponding to the WiFi Network 120. Further, the Authentication Server 104 of the exemplary computer environment 100 is shown. Handshaking among the three components 115, 120, and 104 provide mobile user network access authentication entirely within the MVNO/WiFi Network environment. At steps 1101 and 1202, the user, through the 802.11 radio interface 115, seeks access to the MVNO network 110 and possibly additional subsequent networks 119. This inquiry is automatically transmitted to the WiFi Network 120, shown in FIG. 11 as the Extensible Access Point WLC 120. In response, the WiFi Network, at 1102 transmits an Extensible Access Point (EAP) Identity Request to the Radio Interface 115, asking for an identification of the user device. In this position, the WLC 120 serves as a gatekeeper between the radio interface 115 and the MVNO network 110 and subsequent external networks 119. This request message identifies EAP as the preferred protocol as an indication for how the mobile device 112 is to communicate with the authentication server 104 of the MVNO network.

The mobile device at step 1103 transmits its EAP identity to the access point 120. This identity information is not the IMSI identifier associated with the mobile device but instead is the network access identifier (NAI) of the service provider of the mobile device 112. At step 1104, the EAP identity response in the form of the service provider's NAI is forwarded to the authentication server 104. The received NAI is compared to NAI's stored in the subscriber database 107. Since the subscriber database 107 can include multiple NAI's, the disclosed mobile device authentication system can support mobile devices from a plurality of service providers. If the received NAI does not match any of the NAI's stored in the subscriber database, then the attempt from the radio interface 115 to communicate with the MVNO 110 fails, and the process shown in FIG. 11A and FIG. 12 stops, or terminates (as shown at steps 1122 and 1123 of FIG. 11B and step 1206 of FIG. 12).

If the received NAI matches one of the NAI's stored in the subscriber database, then preliminary trust is established between the authentication server 104 and the radio interface 115. The authentication server 104 then responds at step 1105 through the access point 120, signaling to the mobile device 112 that they can communicate and asking the mobile device 112 whether EAP-TLS can be used as the common authentication protocol among the mobile device 112, access point 120, and authentication server 104 devices. At steps 1106 and 1208, the EAP-TLS inquiry is passed to mobile device 112, asking whether the EAP-TLS protocol can be used as the preferred authentication protocol. This same message provides the identity of the authentication server 104 to the mobile device 112. If the mobile device 112 is configured to utilize the EAP-TLS protocol, an affirmative acknowledgement is transmitted at step 1107 to the access point 120 and further transmitted at steps 1108 and 1210 to the authentication server 104. If no response is received at either the access point 120 or the authentication server 104, the system determines this lack of response as a negative acknowledgement, and the attempted communication from the mobile device 112 stops (as shown at step 1123 of FIG. 11B and step 1206 of FIG. 12). The messages transmitted and received at steps 1107, 1108, and 1210 represent a successful establishment of a service provider level of trust between the mobile device 112 and the authentication server 104 and successful negotiation for determining a common language/protocol, namely that EAP-TLS as the chosen authentication method.

Steps 1109 and 1212 represents the first steps of authenticating the user device 112 for accessing the MVNO network 110 and the networks 119 in a data plane, utilizing the language-specific EAP-TLS protocol. The start EAP-TLS authentication start message originates at the authentication server 104 at step 1109 and is transmitted to the mobile device 112 via the access point 120 at step 1110. In response to receiving the EAP-TLS authentication start message at 1110 and 1214, the mobile device 112 sends its identity information at steps 1111, 1112, and 1216 through the access point 120 to the authentication server 104, thereby greeting the authentication server 104 and beginning the authentication of the mobile device 104 (and thereby the mobile user) to access the MVNO and external, 110 and 119. The messaging to the authentication server 104 at steps 1111, 1112, and 1216 includes the unique, encrypted IMSI identifying the mobile device 112. Further information is included in this messaging to the authentication server, including a list of data cipher algorithms supported by the mobile device 112. The encrypted IMSI of the mobile device 112 is encoded according to the extended TLS 65283 protocol. Also included in the transmitted message from the mobile device 112 is the public key identifying certificate, which is the serial number of the certificate by which the IMSI was encrypted, according to the extended TLS 65282 protocol. This serial number can be transmitted in clear text to the authentication server 104. A database of all serial numbers of certificates that have been used to encrypt IMSI's of mobile devices of the service provider is stored on the authentication server 104, including the extended TLS 65282 and 65283 protocol information. Also stored on the authentication server is a plurality of algorithms/protocols for encrypting and decrypting data across the MVNO network. The authentication server 104 can thereby support multiple encryption types and can resolve authentication requirements without accessing the MNO network. For example, since authentication can take place completely within the MVNO network, there is no need and there is no time lost to repeatedly access the MNO network for identification, authorization, and access each time the mobile device seeks to access the MVNO network. In other words, authentication of the mobile device to access the MVNO network is independent of the MNO network, which has the additional benefit of reducing the load on the MNO network.

The serial number of the certificate can be used if the private key is compromised and can be used to invalidate/replace/discard a public key. The information provided by the mobile device 112 includes the public key that was used to encrypt the IMSI of the mobile device 112. The authentication server 104, upon receiving the transmitted information from the mobile device, knows the public key and the private key for decrypting the IMSI and obtaining the unique identifier of mobile device 112 at step 1113. The authentication server 104 then compares the received serial number of the encryption certificate with the certificate serial numbers stored on the authentication server 104. If there is no match, then the mobile device authentication process stops (as shown at steps 1122 and 1123 of FIG. 11B and step 1206 of FIG. 12). If there is a match of serial numbers, the authentication server 104 utilizes the corresponding encryption protocol to decrypt the IMSI of the mobile device 112 at step 1113 and compares the decrypted IMSI to the IMSI's of authorized remote devices as stored in the authentication server 104, wherein the authentication server contains mobile device protocol information stipulating whether the mobile device is authorized to access the MVNO network. If no match is found, then the mobile device authentication process stops (as shown at steps 1122 and 1123 of FIG. 11B and step 1206 of FIG. 12).

Referring now to FIG. 11B, there is shown a continued flow diagram of an exemplary method for securely connecting a mobile device to a wireless network with control plane only authentication, according to an aspect, once the mobile device's IMSI has been verified. Upon successful decryption of the remote device's IMSI and its match with known mobile devices as that information is stored in one or more databases of the authentication server 104, the authentication server 104 verifies that the mobile device 112 is legitimate, can access the MVNO network, and is authorized to receive data over the MVNO network. At this point, the WiFi extensible access point WLC 120 becomes a passive transport device. The access point 120 can convert wire-based messages and communications from the authentication server 104 to over-the-air messages and communications to the client device 112. The authentication server 104 can also convert over-the-air messages from client device 112 to wired-based messages and communications to the authentication server 104. The protocols for these two types of messaging are different. The communication between access point 120 and the wireless radio interface 115 is by 802.11 radio plane protocol. The communication between the access point 120 and the authentication server is TCPIP.

At step 1114, the authentication server 104 transmits its server certificate through the access point 120 to the radio interface 115 and requests the client device certificate of the mobile device 112. In other words, for continued network access authorization for the mobile device 112, the authentication server 104 requires two pieces of info—the mobile device IMSI (which has already been received and verified at the authentication server 104) and the mobile device certificate—before data communication is allowed. At steps 1114 and 1218, the authentication server 104 also transmits a list of data encryption algorithms/protocols that it supports and the cipher key of the authentication server 104. Further, the message includes a request for the certificate of the mobile device 112. This message from the authentication server 104 comprises a “server hello,” to the mobile device following valid authentication of the mobile device's 112 decrypted IMSI. This process supports the secure authorization requirement for two identifying pieces of information for two factor identification for the mobile device, namely the IMSI of the mobile device and the mobile device certificate. From a broader perspective, the mobile device is allowed on the MVNO network through three factor identification when verification of the mobile device's NAI identifier is considered. Between the mobile device 112 and the service provider 104, ultimately four levels of identification authentication are needed before the mobile device is authorized to access the data plane of the wireless network 110—mobile device NAI service provider verification, mobile device IMSI verification, authentication server certificate, and mobile device certificate. At step 1115, the message, information, and request from the authentication server 104 are forwarded to the mobile device 112.

Authorization server certificates are issued by an independent certificate authority, which also publishes a list of revoked certificates. The list of revoked certificates is checked by the mobile device to determine whether the authorization server certificate is still valid. If the certificate is no longer valid, the authorization of the authorization server certificate fails and the mobile device terminates the conversation at 1123 and 1206. The network access attempt also fails and is terminated if the mobile device certificate is determined to not be valid. At steps 1116 and 1220, both the authorization server 104 and the mobile device 112 have validated the other's respective certificate. At that point, there is a high level of trust between the mobile device 112 and the authentication server 104, and there is no longer any need for the access point 120 to validate or authenticate anything. However, there is still no reason for the mobile device 112 or the authentication server 104 to trust anything or anyone in the middle of their respective transmissions, so the data being passed between the mobile device 112 and the authentication server 104 must be encrypted. The mobile device selects one of the data cipher algorithms/protocols provided by the authentication server 104 that is also supported by the mobile device 112, the selected algorithm/protocol typically being the highest security algorithm/protocol among the mutually supported algorithms/protocols.

Upon verification of the authentication server 104, the mobile device at step 1116 transmits the client certificate and the client cipher key for the selected encryption algorithm to the authentication server 104. This transmission constitutes an agreement at step 1117 that the mobile device 112 and the authorization server 104 agree on the algorithm/protocol for encrypting and decrypting data transmitted between the radio interface 115 and the wireless MVNO network 110 such that the data transmitted between these points remains secure. At steps 1118, 1119, and 1222, the extended EAP-TLS authorization protocol handshaking has been successful, and the data plane transmissions between the mobile device 112 and the wireless MNVO network 110 and any external networks 119 can start, at step 1120. Data is encrypted at the mobile device 112 prior to transmission through the WiFi access point 120 to the MVNO network 110, using the agreed-upon algorithm. The authentication server 104 is no longer involved in any further authentication, and the transmitted data is directed through the access point 120 to its destination, where it will be decrypted based on the agreed-upon algorithm. All data between mobile device 112 and the access point 120 is encrypted on a client-basis because the access point 120 can support multiple clients, each of which has independently negotiated its own encryption algorithm for sending and receiving data.

Referring now to FIG. 8, there is shown a block diagram illustrating example physical components of a computing device 800 or system with which embodiments may be practiced. Computing device 800 can be representative of a server machine, such as one or more of authentication server 104, key generation server 106, or provisioning server 108. It should be appreciated that in other embodiments, different hardware components other than those illustrated in the example of FIG. 8 maybe used.

Computing devices may be implemented in different ways in different embodiments. For instance, in the example of FIG. 8, the computing device 800 includes a processing system 804, memory 802, a network interface card 806 (e.g., wired and/or wireless, cellular type, 802.11 type, etc.), a secondary storage device 808, an input device 810, a video interface 812, a display unit 814, and a communications medium 818. In other embodiments, the computing device 800 may be implemented using more or fewer hardware components (e.g., a video interface, a display unit, or an input device) or in combination with other types of computer systems and applications 826.

The memory 802 includes one or more computer-readable storage media capable of storing data and/or computer-executable instructions. Memory 802 may store computer-executable instructions that, when executed by a processor of the processing system 804, authenticate user devices requesting access to an MVNO network. In various embodiments, the memory 802 is implemented in various ways. For example, the memory 802 can be implemented as various types of computer-readable storage media. Example types of computer-readable storage media include, but are not limited to, solid state memory, flash memory, dynamic random access memory (DRAM), double data rate synchronous dynamic random access memory (DDR SDRAM), DDR2 SDRAM, DDR3 SDRAM, read-only memory (ROM), reduced latency DRAM, electrically-erasable programmable ROM (EEPROM), transitory and non-transitory memory, and other types of devices and/or articles of manufacture that store data.

The term computer-readable storage medium may also refer to devices or articles of manufacture that store data and/or computer-executable instructions readable by a computing device. The term computer-readable storage media encompasses volatile and nonvolatile memory, removable and non-removable media implemented in various methods or technologies for storage and retrieval of information. Such information can include data structures, applications, computer-executable instructions, or other data.

The processing system 804 includes one or more processing units, which may include tangible integrated circuits that selectively execute computer-executable instructions. In various embodiments, the processing units in the processing system 804 are implemented in various ways. For example, the processing units in the processing system 804 can be implemented as one or more processing cores. In this example, the processing system 804 can comprise one or more microprocessors. In another example, the processing system 804 can comprise one or more separate microprocessors. In yet another example embodiment, the processing system 804 can comprise Application-Specific Integrated Circuits (ASICs) that provide specific functionality. In yet another example, the processing system 804 provides specific functionality by using an ASIC and by executing computer-executable instructions.

The computing device 800 may be enabled to send data to and receive data from a communication network via at least one network interface card 806 or circuit. In different embodiments, the network interface card 806 is implemented in different ways, such as an Ethernet interface, a token-ring network interface, a fiber optic network interface, a wireless network interface (e.g., cellular, BLUETOOTH, WiFi, Wi-Max, etc.), or another type of network interface. The network interface may allow the device to communicate with other devices, such as over a wireless network in a distributed computing environment, a satellite link, a cellular link, and comparable mechanisms. Other devices may include computer device(s) that execute communication applications, storage servers, and comparable devices.

The secondary storage device 808 includes one or more computer-readable storage media, and may store data and computer-executable instructions not directly accessible by the processing system 804. That is, the processing system 804 performs an I/O operation to retrieve data and/or computer-executable instructions from the secondary storage device 808. In various embodiments, the secondary storage device 808 can be implemented as various types of computer-readable storage media, such as by one or more magnetic disks, magnetic tape drives, CD-ROM discs, DVD-ROM discs, BLU-RAY discs, solid state memory devices, and/or other types of computer-readable storage media.

The input device 810 enables the computing device 800 to receive input from a user. Example types of input devices include, but are not limited to, keyboards, mice, trackballs, stylus input devices, key pads, microphones, joysticks, touch-sensitive display screens, and other types of devices that provide user input to the computing device 800.

The video interface 812 outputs video information to the display unit 814. In different embodiments, the video interface 812 is implemented in different ways. For example, the video interface 812 is a video expansion card. In another example, the video interface 812 is integrated into a motherboard of the computing device 800. In various embodiments, the display unit 814 can be an LCD display panel, a touch-sensitive display panel, an LED screen, a projector, a cathode-ray tube display, or another type of display unit. In various embodiments, the video interface 812 communicates with the display unit 814 in various ways. For example, the video interface 812 can communicate with the display unit 814 via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The communications medium 816 facilitates communication among the hardware components of the computing device 800. In different embodiments, the communications medium 816 facilitates communication among different components of the computing device 800. For instance, in the example of FIG. 8, the communications medium 816 facilitates communication among the memory 802, the processing system 804, the network interface card 806, the secondary storage device 808, the input device 810, and the video interface 812. In different embodiments, the communications medium 816 is implemented in different ways, such as a PCI bus, a PCI Express bus, an accelerated graphics port (AGP) bus, an InfiniBand® interconnect, a serial Advanced Technology Attachment (ATA) interconnect, a parallel ATA interconnect, a Fiber Channel interconnect, a USB bus, a Small Computing system Interface (SCSI) interface, Serial Peripheral interface (SPI), IIC interface, Universal Asynchronous Receiver/Transmitter (UART) interface, or another type of communications medium.

The memory 802 stores various types of data and/or software instructions. For instance, in the example of FIG. 8, the memory 802 stores a Basic Input/Output System (BIOS) 818 and an operating system 820. The BIOS 818 includes a set of software instructions that, when executed by the processing system 804, cause the computing device 800 to boot up. The operating system 820 includes a set of software instructions that, when executed by the processing system 804, cause the computing device 800 to provide an operating system that coordinates the activities and sharing of resources of the computing device 800. The memory 802 also stores one or more application programs 822 or program code that, when executed by the processing system 804, cause the computing device 800 to provide applications to users. The memory 802 also stores one or more utility programs 824 that, when executed by the processing system 804, cause the computing device 800 to provide utilities to other software programs.

Embodiments may be used in combination with any number of computer systems, such as in server environments, desktop environments, laptop or notebook computer systems, multiprocessor systems, micro-processor based or programmable consumer electronics, networked PCs, mini computers, main frame computers and the like. Embodiments may be utilized in various distributed computing environments where tasks are performed by remote processing devices that are linked through a communications network in a distributed computing environment, and where program code may be located in local and/or remote memory storage (e.g., memory and/or disk(s)).

All system components described herein may be communicatively coupled via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), WAN technologies (T1, Frame Relay), Point-to-Point Protocol over Ethernet (PPoE), etc. including any combination thereof.

FIGS. 9A-9B illustrate a suitable mobile computing device 900 or environment, for example, a mobile computing device or smartphone, a tablet personal computer, a laptop computer, or other end device, with which aspects can be practiced. The mobile computing device 900 is illustrative of any suitable device operative to send, receive and process wireless communications, as well as run applications. A display screen 905 is operative for displaying a variety of information such as information about incoming and outgoing communications, as well as, a variety of data and displayable objects, for example, text, alphanumeric data, photographs, and the like.

Data input to the mobile computing device 900 can be performed via a variety of suitable means, such as, touch screen input via the display screen 905, keyboard or keypad input via a data entry area 910, key input via one or more selectable buttons or controls 915, voice input via a microphone 918 disposed on the mobile computing device 900, photographic input via a camera 925 functionality associated with the mobile computing device 900, or any other suitable input means. Data can be output via the mobile computing device 900 via any suitable output means, including but not limited to, display on the display screen 905, audible output via an associated speaker 930 or connected earphone system, vibration module for providing tactile output, and the like.

Referring now to FIG. 9B, operational unit 935 is illustrative of internal operating functionality of the mobile computing device 900. A processor 940 is illustrative of a computer processor for processing incoming and outgoing data and communications and controlling operation of the device and associated software applications via a mobile computing device operating system. Memory 945 can be utilized for storing a device operating system, device programming, one or more stored applications, for example, mobile telephone applications, data processing applications, calculators, games, Internet browsing applications, navigation applications, acceleration applications, camera and/or video applications, client applications etc.

Mobile computing device 900 can contain an accelerometer 955 for detecting acceleration, and can be used to sense orientation, vibration, and/or shock. Mobile computing device 900 can contain a global positioning system (GPS) system (e.g., GPS send/receive functionality) 960. A GPS system 960 uses radio waves to communicate with satellites orbiting the Earth. Some GPS-enabled mobile computing devices use wireless-assisted GPS to determine a user's location, wherein the device uses orbiting GPS satellites in conjunction with information about the device's mobile phone signal. Radio functions 950 include all required functionality, including onboard antennae, for allowing the mobile computing device 900 to communicate with other communication devices and systems via one or more wireless networks (e.g., cellular, Wi-Fi, Bluetooth, etc.). Radio functions 950 can be utilized to communicate with a wireless or WI-FI-based positioning system to determine a device location.

Aspects, for example, are described above with reference to block diagrams and/or operational illustrations of methods, systems, and computer program products according to embodiments. The functions/acts noted in the blocks can occur out of the order as shown in any flowchart or described herein. For example, two processes shown or described in succession can in fact be executed substantially concurrently or the blocks can sometimes be executed in the reverse order, depending upon the functionality/acts involved.

While certain embodiments have been described, other embodiments may exist. Furthermore, although embodiments have been described as being associated with data stored in memory and other storage mediums, data may also be stored on or read from other types of computer-readable storage media. Further, the disclosed processes may be modified in any manner, including by reordering and/or inserting or deleting a step or process, without departing from the embodiments.

The foregoing description has been presented for the purposes of illustration and description. It is not intended to be exhaustive or to limit the embodiments to the precise forms disclosed. Many modifications and variations are possible in light of the above teaching. It is intended that the scope of the invention be limited not with this detailed description, but rather by the claims appended hereto.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A method for securely connecting to a wireless network with control plane only authentication, comprising:
receiving, at an authentication server of a Mobile Virtual Network Operator (MVNO) network, through a WiFi network, a request from a mobile user device to access the MVNO network;
determining, by the MVNO network, whether the mobile device is associated with the MVNO network;
based on the mobile device being determined to be associated with the MVNO network, transmitting from the MVNO authentication server to the mobile device a request to confirm that an extensible authentication protocol transport layer security (EAP-TLS) can be used as an authentication protocol for authenticating the mobile device to the MVNO authentication server;
in response to receiving at the MVNO network a response from the mobile device confirming that EAP-TLS can be used as the authentication protocol between the mobile device and the MVNO network, transmitting from the MVNO authentication server to the mobile device a request for a unique identifier for the mobile device;
receiving at the MVNO authentication server from the mobile device the unique identifier for the mobile device, wherein the received unique identifier comprises an encrypted International Mobile Subscriber Identity (IMSI) of the mobile device and a serial number for a certificate for a public key for the encrypted IMSI of the mobile device,
retrieving at the MVNO authentication server the public key associated with received the serial number;
decrypting the received IMSI with the retrieved public key;
determining whether the decrypted IMSI is valid;
if the decrypted IMSI is determined to be valid, determining whether the mobile device associated with the decrypted IMSI is authorized to access the MVNO network; and
if the mobile device is determined to be authorized to access the MVNO network, transmitting to the mobile device from the MVNO authentication server authorization to commence data plane transmission at the mobile device.

2. The method according to claim 1, further comprising:
upon determining that the mobile device is authorized to access the MVNO network, transmitting from the MVNO authentication server to the mobile device a server certificate for the MVNO server and a request for a certificate of the mobile device;
if authentication of the transmitted server certificate at the mobile device is successful, receiving from the mobile device at the MVNO authentication server a certificate for the mobile device and a cipher key for encrypting data at the mobile device; and
if authentication of the received mobile device certificate at the MVNO server is successful, transmitting from the MVNO authentication server to the mobile device an identity of an approved encryption algorithm and authorization to commence data plane transmission.

3. The method according to claim 2, further comprising:
if authentication of either the transmitted server certificate or the received mobile device certificate fails, then the mobile device network access attempt fails and terminates.

4. The method according to claim 1, wherein the IMSI of the mobile device and the serial number for the certificate are encoded according to an extended transport layer security (ETLS) protocol.

5. The method according to claim 3, wherein the mobile device and the authentication server utilize extended TLS 65282 and extended TLS 65283 protocols for authenticating access to the MVNO network by the mobile device.

6. The method according to claim 2, wherein successful two factor authentication of the mobile device is required prior to commencing data plane transmission by the mobile device, and wherein the two factor authentication requires validation of the NAI identity of the mobile device and validation of the certificate of the mobile device prior to permitting data plane access by the mobile device.

7. The method according to claim 1, further comprising:
transmitting an Extensible Access Point (EAP) Identity Request to the mobile device, requesting the network access identifier (NAI) of the service provider of the mobile device;
in response to receiving the EAP request, transmitting by the mobile device its EAP identity to the authentication server;
comparing the transmitted EAP identity to service provider EAP's stored in a subscriber database;
if the comparison fails to find an EAP match in the subscriber database, terminating the mobile device's network access; and
if the comparison finds an EAP match in the subscriber database, determining that the mobile device is associated with the MVNO network.

8. The method according to claim 1, further comprising:
upon determining the decrypted IMSI of the mobile device is valid, determining whether the protocols for the mobile device stored in a subscriber database on the authentication server authorize MVNO network access;
if the stored mobile device protocols do not authorize MVNO network access, then terminating the mobile device's network access; and
if the stored mobile device protocols authorize MVNO network access, then commencing an exchange of certificates between the authorization server and the mobile device.

9. A system for securely connecting a mobile device to a wireless network with control plane only authentication, comprising:
a mobile device comprising a wireless 802.11 radio interface;
a WiFi network extensible access point;
a Mobile Virtual Network Operator (MVNO) network authentication server configured to:
receive a request from the mobile user device to access an MVNO network;
determine whether the mobile device is associated with the MVNO network;
based on the mobile device being determined to be associated with the MVNO network, transmit to the mobile device a request to confirm that an extensible authentication protocol transport layer security (EAP-TLS) can be used as an authentication protocol for authenticating the mobile device to the MVNO authentication server;
in response to receiving a response from the mobile device confirming that EAP-TLS can be used as the authentication protocol between the mobile device and the MVNO network, transmit to the mobile device a request for a unique identifier for the mobile device;
receive from the mobile device the unique identifier for the mobile device, wherein the received unique identifier comprises an encrypted International Mobile Subscriber Identity (IMSI) of the mobile device and a serial number for a certificate for a public key for the encrypted IMSI of the mobile device,
retrieve the public key associated with received the serial number;
decrypt the received IMSI with the retrieved public key;
determine whether the decrypted IMSI is valid;
if the decrypted IMSI is determined to be valid, determine whether the mobile device associated with the decrypted IMSI is authorized to access the MVNO network; and
if the mobile device is determined to be authorized to access the MVNO network, transmit to the mobile device authorization to commence data plane transmission at the mobile device.

10. The system according to claim 9, wherein MVNO network authentication server is further configured to:
upon determining that the mobile device is authorized to access the MVNO network, transmit to the mobile device a server certificate for the MVNO server and a request for a certificate of the mobile device;
if authentication of the transmitted server certificate at the mobile device is successful, receive from the mobile device a certificate for the mobile device and a cipher key for encrypting data at the mobile device; and
if authentication of the received mobile device certificate is successful, transmit from the MVNO authentication server to the mobile device an identity of an approved encryption algorithm and authorization to commence data plane transmission.

11. The system according to claim 10, further comprising:
if authentication of either the transmitted server certificate or the received mobile device certificate fails, then the mobile device network access attempt fails and terminates.

12. The system according to claim 9, wherein the IMSI of the mobile device and the serial number for the certificate are encoded according to an extended transport layer security (ETLS) protocol.

13. The system according to claim 12, wherein the mobile device and the authentication server utilize extended TLS 65282 and extended TLS 65283 protocols for authenticating access to the MVNO network by the mobile device.

14. The system according to claim 10, wherein successful two factor authentication of the mobile device is required prior to commencing data plane transmission by the mobile device, and wherein the two factor authentication requires validation of the NAI identity of the mobile device and validation of the certificate of the mobile device prior to permitting data plane access by the mobile device.

15. A server machine for securely connecting a mobile device to a wireless network with control plane only authentication, comprising:
at least one processor;
memory that stores instructions which, when executed by the at least one processor, are configured to:
receive a request from a mobile user device to access an Mobile Virtual Network Operator (MVNO) network;
determine whether the mobile device is associated with the MVNO network;
based on the mobile device being determined to be associated with the MVNO network, transmit to the mobile device a request to confirm that an extensible authentication protocol transport layer security (EAP-TLS) can be used as an authentication protocol for authenticating the mobile device;
in response to receiving a response from the mobile device confirming that EAP-TLS can be used as the authentication protocol between the mobile device and the MVNO network, transmit to the mobile device a request for a unique identifier for the mobile device;
receive from the mobile device the unique identifier for the mobile device, wherein the received unique identifier comprises an encrypted International Mobile Subscriber Identity (IMSI) of the mobile device and a serial number for a certificate for a public key for the encrypted IMSI of the mobile device,
retrieve the public key associated with received the serial number;
decrypt the received IMSI with the retrieved public key;
determine whether the decrypted IMSI is valid;
if the decrypted IMSI is determined to be valid, determine whether the mobile device associated with the decrypted IMSI is authorized to access the MVNO network; and
if the mobile device is determined to be authorized to access the MVNO network, transmit to the mobile device authorization to commence data plane transmission at the mobile device.

16. The server machine according to claim 15, wherein instructions, when executed by the at least one processor, are further configured to:
upon determining that the mobile device is authorized to access the MVNO network, transmit to the mobile device a server certificate for the MVNO server and a request for a certificate of the mobile device;
if authentication of the transmitted server certificate at the mobile device is successful, receive from the mobile device a certificate for the mobile device and a cipher key for encrypting data at the mobile device; and
if authentication of the received mobile device certificate is successful, transmit from the MVNO authentication server to the mobile device an identity of an approved encryption algorithm and authorization to commence data plane transmission.

17. The server machine according to claim 15, wherein the IMSI of the mobile device and the serial number for the certificate are encoded according to an extended transport layer security (ETLS) protocol.

18. The server machine according to claim 17, wherein the mobile device and the authentication server utilize extended TLS 65282 and extended TLS 65283 protocols for authenticating access to the MVNO network by the mobile device.

19. The server machine according to claim 15, wherein instructions, when executed by the at least one processor, are further configured to:
transmit an Extensible Access Point (EAP) Identity Request to the mobile device, requesting the network access identifier (NAI) of the service provider of the mobile device;
in response to receiving the EAP request, transmit by the mobile device its EAP identity to the authentication server;
compare the transmitted EAP identity to service provider EAP's stored in a subscriber database;
if the comparison fails to find an EAP match in the subscriber database, terminate the mobile device's network access; and
if the comparison finds an EAP match in the subscriber database, determine that the mobile device is associated with the MVNO network.

20. The server machine according to claim 15, further comprising:
upon determining the decrypted IMSI of the mobile device is valid, determine whether the protocols for the mobile device stored in a subscriber database on the authentication server authorize MVNO network access;
if the stored mobile device protocols do not authorize MVNO network access, then terminate the mobile device's network access; and
if the stored mobile device protocols authorize MVNO network access, then commence an exchange of certificates between the authorization server and the mobile device.
